(19) United States
(12) Patent Application Publication
(10) Pub. No.: US 2007/0286596 A1
(43) Pub. Date: Dec. 13, 2007

(54) METHOD AND SYSTEM FOR ADJUSTING CAMERA SETTINGS IN A CAMERA EQUIPPED MOBILE RADIO TERMINAL

(76) Inventor: Fredrik A. Lonn, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/422,959

(22) Filed: Jun. 8, 2006

(51) Int. Cl. G03B 17/18; H04N 7/00; G03B 19/00; G06F 3/048; G03B 17/48; H04N 11/00; G03B 29/00

(52) U.S. Cl. 396/429; 715/810; 348/552; 396/287

(57) ABSTRACT

An electronic equipment includes a camera for taking digital photographs. The electronic equipment further includes a display; a keypad adjacent the display, wherein the keypad includes an arrangement of keys; and a control circuit. The control circuit is configured to execute logic to display a menu on the display, wherein the menu has a plurality of menu choices and each menu choice corresponds to one of the keys of the keypad and the menu choices are displayed in an arrangement to graphically present the correspondence between the menu choices and the keys to a user of the electronic equipment; and change camera control settings in accordance with a user selected one of the menu choices, the selected menu choice indicated by user operation of the corresponding key.

### TECHNICAL FIELD OF THE INVENTION

The present invention relates generally to electronic equipment, such as electronic equipment for engaging in voice communications and/or for taking pictures. More particularly, the invention relates to a method and system for adjusting camera settings in a camera equipped mobile radio terminal.

### DESCRIPTION OF THE RELATED ART

Mobile and/or wireless electronic devices are becoming increasingly popular. For example, mobile telephones and portable media players are now in wide-spread use. In addition, the features associated with certain types of electronic devices have become increasingly diverse. To name a few examples, many electronic devices have cameras, text messaging capability, Internet browsing functionality, electronic mail capability, video playback capability, audio playback capability, image display capability and hands-free headset interfaces.

Focusing on a digital camera that is part of a mobile telephone, the user may be presented with the option to place the camera in “night mode” for taking pictures in low light environments. Other operational modes may include, for example, a normal mode and a bright light mode. For most digital cameras, default camera control settings associated with the night mode give priority to certain image attributes over other image attributes. For instance, signal-to-noise ratio may be prioritized over image sharpness. Therefore, photograph images taken in the night mode may be blurred, but may contain less noise.

Some cameras may allow the user to modify camera control settings to place greater priority on other image attributes, such as color saturation or sharpness. However, conventional user interfaces to change default settings for a camera that is integrated with a mobile telephone are cumbersome to user and require a great deal of button pushing. In a typical interface, the user must scroll through menu listings to find a parameter of interest and then take additional action to change the setting. Such a process is time consuming, especially if the user wishes to change multiple parameters. In some situations, attempting to change one or more camera parameter settings before taking a picture could result in losing the opportunity to capture any image of the desired photograph subject matter. Accordingly, there is a need in the art for an improved way of adjusting digital camera settings.

### SUMMARY

According to one aspect of the invention, a method of changing camera control settings for a camera of a mobile radio terminal that includes a keypad adjacent a display and the keypad includes an arrangement of alphanumeric keys includes activating the camera; displaying a menu on the display, the menu having a plurality of menu choices, each menu choice corresponding to one of the alphanumeric keys of the keypad and the menu choices displayed in an arrangement to graphically present the correspondence between the menu choices and the keys to a user of the mobile radio terminal; and changing camera control settings in accordance with a user selected one of the menu choices, the selected menu choice indicated by user operation of the corresponding key.

According to another aspect of the method, the alphanumeric keys form a telephone dialing portion of the keypad and are used to enter a telephone number or contact information in preparation for placing a call with the mobile radio terminal.

According to another aspect of the method, the keypad further includes at least one function key separate from the arrangement of alphanumeric keys.

According to another aspect of the method, displaying the menu is in response to operation of a key from the keypad.

According to another aspect of the method, at least some of the menu choices correspond to camera control settings that prioritize an image parameter over a default priority image parameter for a currently active operational mode of the camera.

According to another aspect of the method, the image parameters are selected from the group of resolution, color, brightness, sharpness, contrast, image file size, signal-to-noise ratio and combinations thereof.

According to another aspect of the method, prioritizing an image parameter involves two key strokes by the user, including a first keystroke to display the menu and a second keystroke to select one of the menu choices.

According to another aspect of the method, the menu choices correspond to operational themes for the camera.

According to another aspect of the method, the method further includes emphasizing keys from the keypad that have correspondence to the menu choices using a keypad illumination technique.

According to another aspect of the method, the method further includes taking a photograph using a set of camera control settings that correspond to the selected one of the menu choices.

According to another aspect of the invention, a mobile radio terminal includes a radio circuit for establishing communication with a communications network; a camera for taking digital photographs; a display; a keypad adjacent the display, wherein the keypad includes an arrangement of alphanumeric keys; and a control circuit. The control circuit is configured to execute logic to display a menu on the display, wherein the menu has a plurality of menu choices and each menu choice corresponds to one of the alphanumeric keys of the keypad and the menu choices are displayed in an arrangement to graphically present the correspondence between the menu choices and the keys to a user of the mobile radio terminal; and change camera control settings in accordance with a user selected one of the menu choices, the selected menu choice indicated by user operation of the corresponding key.

According to another aspect of the mobile radio terminal, the alphanumeric keys form a telephone dialing portion of the keypad and are used to enter a telephone number or contact information in preparation for placing a call with the mobile radio terminal.

According to another aspect of the mobile radio terminal, the keypad further includes at least one function key separate from the arrangement of alphanumeric keys.

According to another aspect of the mobile radio terminal, at least some of the menu choices correspond to camera control settings that prioritize an image parameter over a default priority image parameter for a currently active operational mode of the camera.

According to another aspect of the mobile radio terminal, the image parameters are selected from the group of resolution, color, brightness, sharpness, contrast, image file size, signal-to-noise ratio and combinations thereof.

According to another aspect of the mobile radio terminal, prioritizing an image parameter involves two key strokes by the user, including a first keystroke to display the menu and a second keystroke to select one of the menu choices.

According to another aspect of the mobile radio terminal, the menu choices correspond to operational themes for the camera.

According to another aspect of the mobile radio terminal, the control circuit controls illumination of the keys of the keypad to emphasize keys from the keypad that have correspondence to the menu choices.

According to another aspect of the invention, an electronic equipment includes a camera for taking digital photographs; a display; a keypad adjacent the display, wherein the keypad includes an arrangement of keys; and a control circuit. The control circuit is configured to execute logic to display a menu on the display, wherein the menu has a plurality of menu choices and each menu choice corresponds to one of the keys of the keypad and the menu choices are displayed in an arrangement to graphically present the correspondence between the menu choices and the keys to a user of the electronic equipment; and change camera control settings in accordance with a user selected one of the menu choices, the selected menu choice indicated by user operation of the corresponding key.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1a is a schematic front view of a mobile telephone as an exemplary electronic equipment in accordance with an embodiment of the present invention;

FIG. 1b is a schematic rear view of the mobile telephone of FIG. 1a;

FIG. 2 is a schematic block diagram of the relevant portions of the mobile telephone of FIG. 1 in accordance with an embodiment of the present invention;

FIG. 3 is a schematic diagram of a communications system in which the mobile telephone of FIG. 1 may operate;

FIG. 4 is a flow chart of an exemplary camera function in accordance with the present invention;

FIG. 5 is another exemplary representation of a mobile telephone as an exemplary electronic equipment when the mobile telephone is placed in a camera mode;

FIGS. 6 and 7 are exemplary representations of the mobile telephone of FIG. 5 in a setting adjustment phase of the camera mode while displaying on-screen camera setting adjustment menu choices; and

FIGS. 8 and 9 are additional exemplary graphical representations of on-screen camera setting adjustment menu choices.

### DETAILED DESCRIPTION OF EMBODIMENTS

The present invention will now be described with reference to the drawings, wherein like reference numerals are used to refer to like elements throughout. It will be understood that the figures are not necessarily to scale.

The term “electronic equipment” includes portable radio communication equipment. The term “portable radio communication equipment,” which herein after is referred to as a “mobile radio terminal,” includes all equipment such as mobile telephones, pagers, communicators, electronic organizers, personal digital assistants (PDAs), smartphones, portable communication apparatus or the like.

In the present application, the invention is described primarily in the context of a mobile telephone. However, it will be appreciated that the invention is not intended to be limited to a mobile telephone and can be any type of appropriate electronic equipment. Also, embodiments of the invention are described primarily in the context of changing digital camera settings in preparation for taking a still photograph. However, it will be appreciated that the invention is not intended to be limited to the changing of still camera settings. For instance, the invention may have application to the changing of settings for taking a movie (e.g., video clip) or changing the settings of another accessory of the electronic equipment.

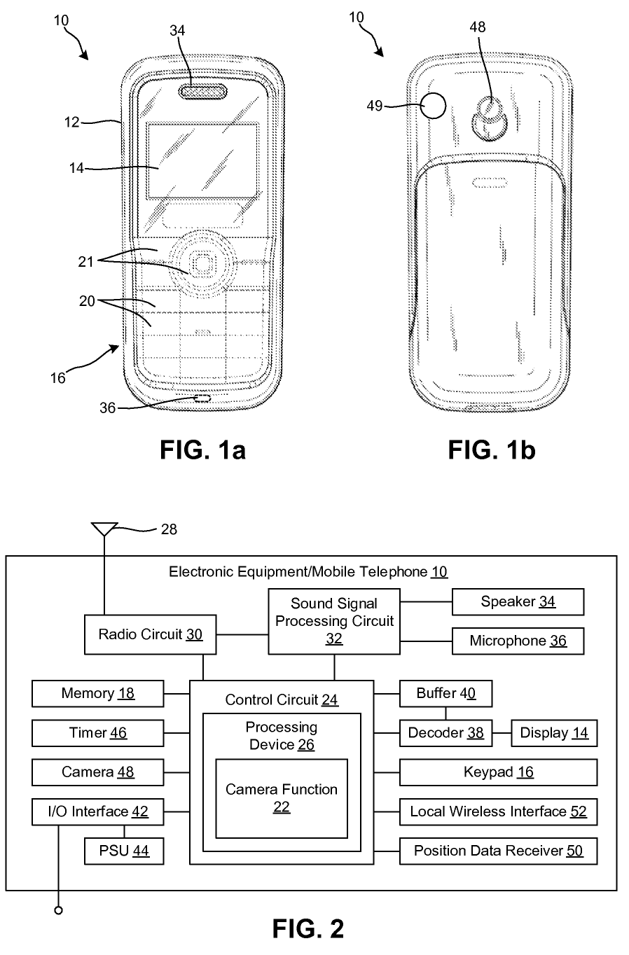

Referring initially to FIGS. 1a and 1b, an electronic equipment 10 is shown in accordance with the present invention. The electronic equipment includes a camera function that is configured to control a camera of the electronic equipment and process image data captured by the camera. It will be appreciated that the camera function may be embodied as executable code that may be resident in and executed by the electronic equipment 10.

The electronic equipment in the illustrated embodiments is a mobile telephone and will be referred to as the mobile telephone 10. The mobile telephone 10 is shown as having a “brick” or “block” form factor housing 12, but it will be appreciated that other type housings, such as a clamshell housing or a slide-type housing, may be utilized.

The mobile telephone 10 includes a display 14 and keypad 16. The display 14 displays information to a user such as operating state, time, telephone numbers, contact information, various navigational menus, etc., which enable the user to utilize the various features of the mobile telephone 10. The display 14 may also be used to visually display content received by the mobile telephone 10 and/or retrieved from a memory 18 (FIG. 2) of the mobile telephone 10. In addition, an image may be displayed on the display 14, such as a photograph taken by a camera of the mobile telephone 10 or a photo preview image when the display 14 functions as an electronic viewfinder for the camera. As will be described in greater detail below, a camera setting menu, or “optimization menu,” may be displayed on the display 14 to graphically assist the user change camera setting before taking a photograph.

The keypad 16 may provide for a variety of user input operations. For example, the keypad 16 may include alphanumeric keys 20 for allowing entry of alphanumeric information such as telephone numbers, phone lists, contact information, notes, etc. In addition, the keypad 16 may include special function keys 21 such as a “call send” key for initiating or answering a call, and a “call end” key for ending or “hanging up” a call. Special function keys 21 may also include menu navigation keys, for example, for navigating through a menu displayed on the display 14 to select different telephone functions, profiles, settings, etc., as is conventional. Other keys associated with the mobile telephone may include a volume key, an audio mute key, an on/off power key, a web browser launch key, a camera key, etc. Keys or key-like functionality may also be embodied as a touch screen associated with the display 14.

The mobile telephone 10 includes conventional call circuitry that enables the mobile telephone 10 to establish a call and/or exchange signals with a called/calling device, typically another mobile telephone or landline telephone. However, the called/calling device need not be another telephone, but may be some other device such as an Internet web server, content providing server, etc. The call circuitry also may be responsible for transmitting text messages that are prepared by the user.

With additional reference to FIG. 2, additional components of the mobile telephone 10 will be described. For the sake of brevity, generally conventional features of the mobile telephone 10 will not be described in great detail herein. The mobile telephone 10 includes a primary control circuit 24 that is configured to carry out overall control of the functions and operations of the mobile telephone 10. The control circuit 24 may include a processing device 26, such as a CPU, microcontroller or microprocessor. The processing device 26 executes code stored in a memory (not shown) within the control circuit 24 and/or in a separate memory, such as memory 18, in order to carry out operation of the mobile telephone 10. The memory 18 may be, for example, one or more of a buffer, a flash memory, a hard drive, a removable media, a volatile memory, a non-volatile memory or other suitable device. In addition, the processing device 26 executes code in order to perform a camera function 22.

It will be apparent to a person having ordinary skill in the art of computer programming, and specifically in applications programming for mobile telephones or other electronic devices, how to program a mobile telephone 10 to operate and carry out the functions described herein. Accordingly, details as to the specific programming code have been left out for the sake of brevity. Also, while the camera function 22 is executed by the processing device 26 in accordance with the preferred embodiment of the invention, such functionality could also be carried out via dedicated hardware, firmware, software, or combinations thereof, without departing from the scope of the invention.

Continuing to refer to FIGS. 1a, 1b and 2, the mobile telephone 10 includes an antenna 28 coupled to a radio circuit 30. The radio circuit 30 includes a radio frequency transmitter and receiver for transmitting and receiving signals via the antenna 28 as is conventional. The radio circuit 30 may be configured to operate in a mobile communications system. The radio circuit 30 may be further configured to receive data and/or audiovisual content. For example, the receiver may be an IP datacast compatible receiver compatible with a hybrid network structure providing mobile communications and digital broadcast services, such as DVB-H mobile television and/or mobile radio. Other receivers for interaction with a mobile radio network or broadcasting network are possible and include, for example, GSM, CDMA, WCDMA, MBMS, WiFi, WiMax, DVB-H, ISDB-T, etc.

The mobile telephone 10 further includes a sound signal processing circuit 32 for processing audio signals transmitted by/received from the radio circuit 30. Coupled to the sound processing circuit 32 are a speaker 34 and a microphone 36 that enable a user to listen and speak via the mobile telephone 10 as is conventional. The radio circuit 30 and sound processing circuit 32 are each coupled to the control circuit 24 so as to carry out overall operation. Audio data may be passed from the control circuit 24 to the sound signal processing circuit 32 for playback to the user. The audio data may include, for example, audio data from an audio file stored by the memory 18 and retrieved by the control circuit 24. The sound processing circuit 32 may include any appropriate buffers, decoders, amplifiers and so forth.

The mobile telephone 10 also includes the aforementioned display 14 and keypad 16 coupled to the control circuit 24. The display 14 may be coupled to the control circuit 24 by a video decoder 38 that converts video data to a video signal used to drive the display 14. The video data may be generated by the control circuit 24, retrieved from a video file that is stored in the memory 18, derived from an incoming video data stream received by the radio circuit 30 or obtained by any other suitable method. Prior to being fed to the decoder 38, the video data may be buffered in a buffer 40.

The mobile telephone 10 further includes one or more I/O interface(s) 42. The I/O interface(s) 42 may be in the form of typical mobile telephone I/O interfaces and may include one or more electrical connectors. As is typical, the I/O interface(s) 42 may be used to couple the mobile telephone 10 to a battery charger to charge a battery of a power supply unit (PSU) 44 within the mobile telephone 10. In addition, or in the alternative, the I/O interface(s) 42 may serve to connect the mobile telephone 10 to a wired personal hands-free adaptor (not shown), such as a headset (sometimes referred to as an earset) to audibly output sound signals output by the sound processing circuit 32 to the user. Further, the I/O interface(s) 42 may serve to connect the mobile telephone 10 to a personal computer or other device via a data cable. The mobile telephone 10 may receive operating power via the I/O interface(s) 42 when connected to a vehicle power adapter or an electricity outlet power adapter.

The mobile telephone 10 may also include a timer 46 for carrying out timing functions. Such functions may include timing the durations of calls, generating the content of time and date stamps, etc.

As indicated, the mobile telephone 10 may include a camera 48 for taking digital pictures and/or movies. Image and/or video files corresponding to the pictures and/or movies may be stored in the memory 18. In some embodiments, the mobile telephone 10 may include a flash 49 for assisting the camera 48 take photographs in certain illumination conditions as will be understood by one of ordinary skill in the art.

The mobile telephone 10 also may include a position data receiver 50, such as a global positioning system (GPS) receiver, Galileo satellite system receiver or the like. The mobile telephone 10 also may include a local wireless interface 52, such as an infrared transceiver and/or an RF adaptor (e.g., a Bluetooth adapter), for establishing communication with an accessory, a hands-free adaptor (e.g., a headset that may audibly output sounds corresponding to audio data transferred from the mobile telephone 10 to the adapter), another mobile radio terminal, a computer or another device.

The mobile telephone 10 may be configured to transmit, receive and process data, such as text messages (e.g., colloquially referred to by some as “an SMS”), electronic mail messages, multimedia messages (e.g., colloquially referred to by some as “an MMS”), image files, video files, audio files, ring tones, streaming audio, streaming video, data feeds (including podcasts) and so forth. Processing such data may include storing the data in the memory 18, executing applications to allow user interaction with data, displaying video and/or image content associated with the data, outputting audio sounds associated with the data and so forth.

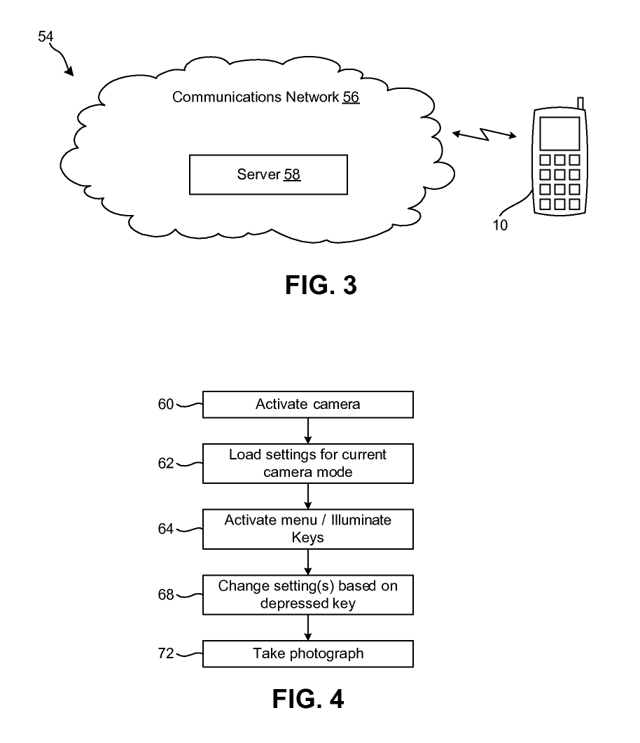

With additional reference to FIG. 3, the mobile telephone 10 may be configured to operate as part of a communications system 54. The system 54 may include a communications network 56 having a server 58 (or servers) for managing calls placed by and destined to the mobile telephone 10, transmitting data to the mobile telephone 10 and carrying out any other support functions. The server communicates with the mobile telephone 10 via a transmission medium. The transmission medium may be any appropriate device or assembly, including, for example, a communications tower, another mobile telephone, a wireless access point, a satellite, etc. Portions of the network may include wireless transmission pathways. The network 56 may support the communications activity of multiple mobile telephones 10, although only one mobile telephone 10 is shown in the illustration of FIG. 3.

In one embodiment, the server 58 may operate in stand alone configuration relative to other servers of the network 56 or may be configured to carry out multiple communications network 58 functions. As will be appreciated, the server 58 may be configured as a typical computer system used to carry out server functions and may include a processor configured to execute software containing logical instructions that embody the functions of the server 58.

With additional reference to FIG. 4, illustrated is a flow chart of logical blocks that make up certain features the camera function 22. The flow chart may be thought of as depicting steps of a method. Although FIG. 4 shows a specific order of executing functional logic blocks, the order of execution of the blocks may be changed relative to the order shown. Also, two or more blocks shown in succession may be executed concurrently or with partial concurrence. Certain blocks also may be omitted. In addition, any number of commands, state variables, semaphores or messages may be added to the logical flow for purposes of enhanced utility, accounting, performance, measurement, troubleshooting, and the like. It is understood that all such variations are within the scope of the present invention.

The method may begin in block 60 by activating the camera 48. Activating the camera 48 may be invoked by user action, such as by pressing a particular key of the keypad 16. Activating the camera 48 may turn on the camera 48 or otherwise ready the camera 48 to take a photograph. In one embodiment, the display 14 may be used as an electronic viewfinder for the camera 48.

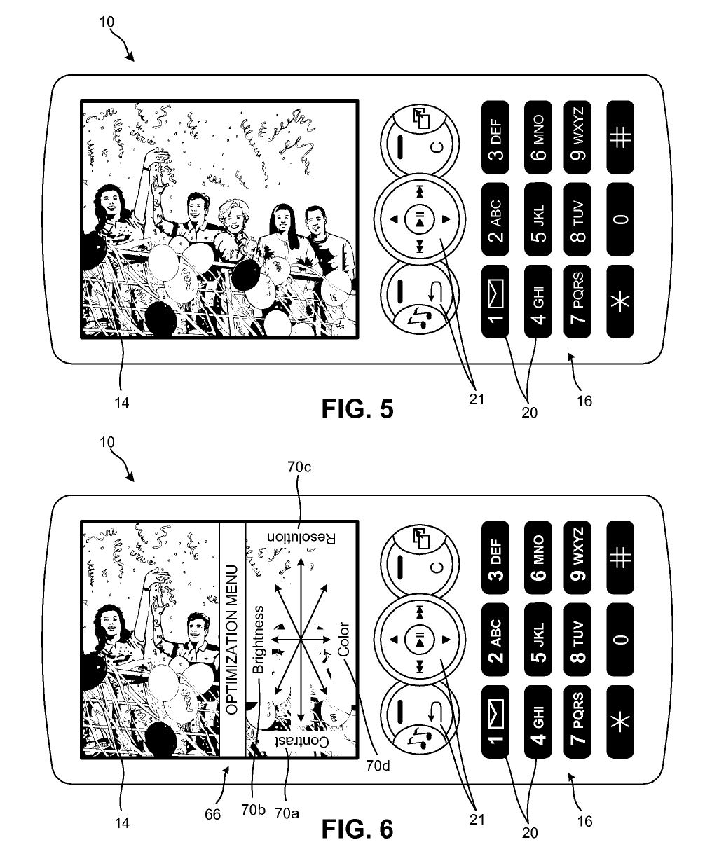

With additional reference to FIG. 5, shown is an exemplary mobile telephone 10 for which a camera 48 of the mobile telephone 10 has been turned on and the display 14 is used as a viewfinder. During use as a viewfinder, the display 14 may show images detected by the camera 48 to provide the user with an indication of the field of view of the camera 48 and what may be contained in a picture if a photograph were to be taken at that moment in time. The display 14 may be refreshed so that the image displayed on the display is a current representation of the field of view of the camera 48. In the illustrated example, the display 14 shows an image of a group of people who are in the field of view of the camera 48. The camera 48 is not illustrated in FIG. 5 as, in this embodiment, a lens of the camera 48 is located on an opposite side of the mobile telephone 10 from the display 14.

In the illustrated embodiment of FIG. 5, the mobile telephone 10 has function keys 21 and alphanumeric keys 20. The function keys 21 in this illustrated embodiment are specially marked for audiovisual content playback. These keys 21 may serve other functions when the mobile telephone 10 is used for various purposes. For example, the keys 21 may serve as a user interface for menu navigation, a user interface for camera activation and shutter operation, and so forth. Thus, the illustration of markings for audiovisual content playback on the keys 21 is for exemplary purposes and it will be understood that the function keys 21 may bear other markings. The alphanumeric keys 20 are those that one would typically find on a telephone keypad. As indicated, the keys 20 may be used to enter numbers or text, and may have additional functionality in certain operational modes of the mobile telephone 10. It will be appreciated that the number, function and arrangement of keys 20 and/or 21, as well as the text or symbols shown on the keys 20 and/or 21, may vary from mobile telephone 10 to mobile telephone 10.

Proceeding to block 62, the camera 48 may be placed in a camera mode by default operation, or by either of user action or automatic action based on sensed conditions, such as illumination. Various camera modes may include, for example, a normal or default mode, a night (or low light) mode, a bright light mode, a high speed or action mode, a portrait mode, a landscape mode, a macro mode, a black and white mode, combinations of modes, etc. Each mode may have an associated set of default camera control settings that are selected to prioritize a certain image attribute(s) (also referred to as image parameter(s)) over other image attributes. As an example, the night mode setting may adjust various aspects of camera operation and/or detected image processing to give priority to signal-to-noise ratio. Examples of camera control settings include shutter speed, f-stop, ISO sensitivity, image color processing, flash operation and so forth. Accordingly, in block 62 camera control settings for the current camera mode may be loaded.

The mobile telephone 10 may be configured to allow the user to change settings of the camera 48. For instance, the user may desire to override currently loaded settings so as to place priority on one or more desired parameters, such as resolution, color, brightness, sharpness, contrast, file size, signal-to-noise ratio and so forth. Accordingly, the camera function 22 may generate a menu in graphical user interface (GUI) format that coordinates with the keys 20 and/or 21 of the mobile telephone.

With additional reference to FIG. 6, and proceeding to block 64, a menu 66 may be activated following user action. The menu 66 may be generated by the camera function 22 as a user interface to allow manual changes to the camera settings to be made. The changeable camera settings may be set forth in the menu 66 in terms of the desired effect on image results, such as color, brightness, sharpness, contrast, resolution, signal-to-noise ratio, etc. It will be appreciated that the camera function 22 may translate a user selected setting(s) from the menu to camera control settings (such as shutter speed, f-stop, ISO sensitivity, image color processing, flash operation and so forth) for implementation when taking a photograph. In other embodiments, the menu 66 may provide the user with the ability to directly change the camera control settings.

The user action to activate the menu 66 may be the depression of one of the keys 20 or 21. The activating key may be a specific key 20 or 21, or any one of the keys 20 and/or 21. In the embodiment described herein, menu 66 activation is achieved by depressing any one of the alphanumeric keys 20 labeled “one” through “nine.” Activating the menu 66 may include displaying options on the display 14 from which the user may choose to invoke a departure from the currently loaded settings. Thus, the menu 66 may allow the user to change one or more parameters associated with the camera 48 so as to provide the user with at least partial manual control over the camera settings. In this sense, the menu 48 allows the user to attempt to optimize the image quality by providing direct or indirect access to the camera control settings.

The menu 66 may be added to the display 14 along with the viewfinder image presented on the display 14, such as by overlaying the menu 66 on the viewfinder image. In other embodiment, when the menu 66 is displayed, the viewfinder image may be temporarily turned-off. The menu 66 may be displayed in an orientation that corresponds to the keypad 16. In the illustration of FIG. 6, the mobile telephone 10 is oriented horizontally. Thus, the menu 66 may appear to the user to be rotated relative to the image, but is oriented to have a functional correspondence to the keys 20. If the mobile telephone 10 were oriented vertically, the menu 66 would appear to be oriented in a consistent manner with the image. In other embodiments, the menu 66 may be displayed to have a consistent orientation with the image (e.g., the camera function 22 could logically rotate the menu 66 ninety degrees for display when the mobile telephone 10 is held in a horizontal manner).

The displayed menu 66 is arranged such that menu choices have correspondence to the keys 20 and/or 21 of the keypad 16. Thus, each menu choice may be associated with a corresponding key 20 or 21 of the keypad 16. The menu 66 is specifically arranged so that menu choices intuitively correspond to particular keys 20 or 21 of the keypad 16. In the illustrated embodiment, each menu choice corresponds directly to a key from a telephone dialing keypad portion of the keypad 16. Thus, in the illustrated embodiment, each menu choice corresponds directly to one of the alphanumeric keys 20, and more particularly to the one of the alphanumeric keys 20 labeled “one” through “nine.”

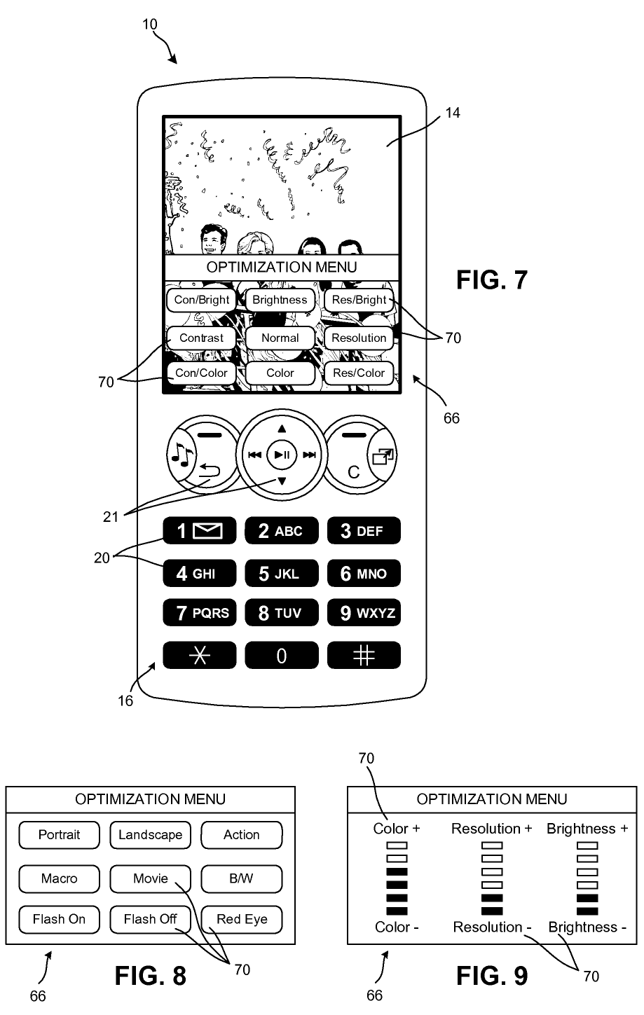

To assist the user draw a cognitive correlation between displayed menu choices and associated keys 20 and/or 21, the keys 20 and/or 21 that correspond to the menu choices may be illuminated. Referring to the illustrated example, the alphanumeric keys 20 that are labeled “one” through “nine” have correspondence to menu choices of the displayed menu 66, as will be described in greater detail below. Thus, the alphanumeric keys 20 that are labeled “one” through “nine” may be illuminated under the control of the camera function 22 while the remaining keys 20 (e.g., the star key, the zero key and the pound key) and the function keys 21 may be in an unilluminated state or in a dimly illuminated state. The keys 20 in FIGS. 5, 6 and 7 are illustrated to represent translucent characters surrounded by opaque key surfaces. The illuminated keys in FIGS. 6 and 7 are shown using bold text and lines on a black background to represent light being emitted by the translucent character regions. Variations to the key illumination scheme are possible and include, for example, changing the color of light associated the certain keys, emitting light around certain keys, turning off illumination to keys that were previously lit but do not have correspondence to menu choices, and so on. Also, variations in key arrangement are possible, such as a translucent key with dark or opaque text or symbols.

Proceeding to block 68, the user may press a key 20 or 21 corresponding to a desired menu choice to change the currently loaded camera control settings. In one embodiment, after a selection is made, the appropriate camera control settings are updated and the menu 66 is removed from the display 14, thereby readying the camera 48 to take a photograph using the revised settings. In this embodiment, changing camera control settings can be carried out using very few keystrokes. For instance, if the camera 48 were in night mode, but the user wanted to prioritize resolution over a default priority of signal-to-noise ratio, the user may make one keystroke to activate the menu and then a second keystroke to select resolution as the priority. Such action may be carried out rapidly to reduce the risk that the user may miss a photo opportunity in the time it may take to change camera settings. In conventional menu navigation systems, prioritizing an image parameter may not be possible or may be changed only by using a large number of keystrokes to navigate through nested menus.

Thus far, the correlation between menu choices and keys 20 and/or 21 has been discussed in the conceptual sense. FIGS. 6 through 9 illustrate various exemplary menus 66. Each illustrated menu 66 has a set of menu choices 70. These examples are described below to demonstrate various aspects of the camera function 22, and the interaction between menu choices 70 and keys 20 and/or 21. While the menu choices 70 of the illustrated menus 66 are selected by depressing corresponding keys 20 and/or 21, the display 14 may be implemented as a touch screen such that pressure placed directly on a displayed menu choice 70 may invoke corresponding action by the camera function 22.

In the embodiment of FIG. 6, the menu 66 graphically presents four camera priority settings as menu choices 70, including contrast 70a, brightness 70b, resolution 70c and color 70d. The menu choices 70 relate to image parameters and are arranged such that by depressing a corresponding alphanumeric key 20, the camera function 22 will adjust the camera control settings to prioritize the selected image parameter. For instance, the “two” key corresponds to the brightness menu choice 70b, the “four” key corresponds to the contrast menu choice 70a, the “six” key corresponds to the resolution menu choice 70c and the “eight” key corresponds to the color menu choice 70d. Other keys may have correspondence to other menu choices, which may be displayed as part of the menu 66 or not displayed. For instance, the “one” key may corresponding to prioritizing a combination of contrast and brightness, the “three” key may correspond to prioritizing a combination of brightness and resolution, the “seven” key may correspond to prioritizing a combination of contrast and color and the “nine” key may correspond to prioritizing a combination of color and resolution. The “five” key may correspond to a default image attribute priority, such as the attribute(s) prioritized under the normal operational mode.

In the foregoing example of FIG. 6, the menu includes nine exemplary menu choices 70, each of which correspond to a different predetermined collection of camera control settings. The same nine exemplary menu choices 70 are presented in the menu 66 of FIG. 7, but where the choices 70 are graphically arranged to resemble the keys 20 of the keypad 16. In either example, the relative positioning of the menu choices 70 is informative to the user as to which key 20 to depress to effect corresponding changes to the camera control settings.

As indicated, for each menu choice 70, the camera function 22 may apply a set of camera control settings. Each setting in the set may be predetermined. In one embodiment, the camera function 22 may use a look-up table containing a value for each possible camera control setting for each possible user selectable menu choice. Thus, when taking a photograph, the predetermined camera control setting values for the user selected menu choice (if made) are used to control camera 48 operation. In another embodiment, the menu choices may have application to the currently active camera mode for which settings are loaded in block 62. In this case, the look-up table may contain a value for each possible camera control setting for each possible operational camera mode and for each possible user selectable menu choice within each operational mode. Thus, in this alternative embodiment, for an operational mode that has nine menu choices, there may be ten sets of camera control settings, including one for the default combination of settings and nine combinations of settings for each user selectable image parameter priority.

As one example, it may be assumed that the user selects a menu choice 70 to prioritize the color image parameter over currently loaded camera control settings, which may give priority to a different image parameter, such as signal-to-noise ratio. Image color may depend on how image data captured by the camera 48 is processed. Color information for any one pixel may be determined by taking an average of detected color over neighboring pixels. The larger the number of pixels used in the averaging, the higher the image color quality may be, but resolution may be sacrificed. Therefore, if the user were to make a menu selection to prioritize the image based on color, the camera function 22 may alter the number of pixels used when processing image data to make a color determination for each pixel. As another example, user action to prioritize brightness may result in the camera function 22 changing camera control settings that relate to brightness, such as f-stop and shutter speed. While prioritizing brightness may sacrifice sharpness and resolution, image quality may be improved in certain lighting conditions.

With additional reference to FIG. 8, another exemplary menu 66 is shown apart from the remaining components of the mobile telephone 10. The menu 66 of FIG. 8 is arranged in the manner shown in connection with FIG. 7, but where the user choices 70 relate to operational themes or functions for the camera 48. For instance, the upper left hand theme is identified as “portrait” for taking pictures of people that are relatively close to the camera 48 and corresponds to the “one” key. The upper center theme is “landscape” for taking pictures of scenery and corresponds to the “two” key. The upper right theme is “action” for taking pictures of fast moving targets (e.g., sporting events, moving animals, etc.) and corresponds to the “three” key. The middle left theme is “macro” for taking pictures of close-up objects and corresponds to the “four” key. The middle center theme is “movie” for activating a video recording mode of the camera 48 and corresponds to the “five” key. The middle right theme is “black and white” for taking non-color pictures and corresponds to the “six” key. The lower left key may be used to turn on the flash 49 (FIG. 1b) and corresponds to the “seven” key. The lower center key may be used to turn off the flash 49 and corresponds to the “eight” key. The lower right key may be used to control the flash 49 to reduce red-eye and corresponds to the “nine” key. Other possible themes for which menu choices may be made available include a normal camera mode, a nigh mode and/or a bright light mode.

Selection of a menu choice 70 from the exemplary menu 66 of FIG. 8 will result in the camera function 22 making appropriate changes to the camera control settings to support the selected theme or function. In one embodiment, the theme based menu choices 70 exemplified by the menu 66 of FIG. 8 may be made available to the user by pressing one menu activation key (e.g., one of the function keys 21) and the image attribute prioritization choices 70 exemplified by the menus 66 of FIGS. 6 and 7 may be made available to the user by pressing a different menu activation key. In another embodiment, the theme based choices exemplified in the menu 66 of FIG. 8 may be made available to the user when the camera 48 is a normal operational mode and the image parameter priority based menu choices 70 exemplified by the menus 66 of FIGS. 6 and 7 may be made available to the user when the camera 48 is in a non-normal mode (e.g., the night mode or bright light mode).

Other menu arrangements are possible and include, for example, a menu that includes both image attribute based choices and theme/function choices. Also, the presented menu choices may be the same no matter when the menu 66 is activated. Alternatively, the presented menu choices may change based on the currently active operational mode of the camera. For example, if the camera were already in night mode where signal-to-noise ratio is prioritized, then the menu choices may be those illustrated in FIG. 6, but if the camera were in another mode where resolution is the priority, the resolution choice may be changed to another image attribute.

With additional reference to FIG. 9, another exemplary menu 66 is shown apart from the remaining components of the mobile telephone 10. The menu 66 of FIG. 9 has menu choices 70 that correspond to adjustable parameters. In the illustrated example, three parameters are presented, including color, resolution and brightness. The user may increase or decrease the weighting of the parameters in relationship to one another by pressing keys 20 that correspond to the menu choices 70. The selected weighting given to each parameter may be displayed graphically, such as with the illustrated empty and filled bars. In the illustrated example, “color+” and “color−” are opposing menu choices that respectively correspond to the “one” and “seven” keys. The “one” key may be depressed to increase color and the “seven” key may be depressed to decrease color, much in the way that one might control volume on a television using a remote control having a volume up key and a volume down key. Similarly, the “two” key may be depressed to increase resolution and the “eight” key may be depressed to decrease resolution. Also, the “three” key may be depressed to increase brightness and the “nine” key may be depressed to decrease brightness. Multiple key strokes may be used to step through the available weighting levels for each parameter. Alternatively, a key may be held down to advance through multiple weighting levels. In the embodiment of FIG. 9, when the user is done making adjustments to the various parameters, the user may depress an end button (e.g., one of the function keys 21) or otherwise indicate that he or she is done using the menu 66. At that time, corresponding camera control settings may be changed and the menu 66 may be removed from the display 14.

In the examples of FIGS. 6-8, changes to camera control settings may be made by pressing a single key 20 or 21, thereby offering the advantage of speed. As indicated, the settings may take effect and the menu 66 may be removed from the display 14 upon pressing of the corresponding key and without the need to depress an end or done key. In the example of FIG. 9, multiple key depressions may be made to make adjustments to camera control settings based on one or more parameters, thereby offering the advantage of greater user control over image attributes.

Any of the user interfaces described herein may be modified to provide a desired arrangement of menu choices 70 to the user. Illustrated and/or described menu choices may be replaced by other menu choices or additional menu choices may be added to those shown and/or described. Two such possible parameters that are not illustrated, but may be included in menu choices are image file size and image sharpness. Scroll features may be added to allow the user to display additional menu choices 70. For instance, the “star” key may be used to move (or pan) displayed menu choices 70 upward or to the left to show more choices and the “pound” key may be used to move (or pan) displayed choices 70 downward or to the right to show more choices. When scrolling through menu choices 70, changes to the displayed menu choices 70 and key 20 and/or 21 operation may be coordinated so that the relationship between currently displayed menu choices 70 and the keys 20 and/or 21 of the keypad 16 may be maintained.

Also, in the illustrated examples, text is used to present menu choices 70. It will be appreciated that icons or a combination of icons and text may be used to present menu choices 70. In addition, each menu choice 70 may be combined with a number, letter or symbol shown on the key 20 or 21 that corresponds to the menu choice 70.

Returning to FIG. 4, after any changes to the camera control settings are made based on a depressed key 20 or 21 that corresponds to a menu choice 70, the logical flow may proceed to block 72 where the logic may wait for the user to press a shutter key. Upon pressing of the shutter key, the camera 48 may be controlled to take a photograph, the captured image data may be processed and placed in an appropriate image file format, and the image data may be saved (e.g., stored in memory 18) for subsequent retrieval.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A method of changing camera control settings for a camera of a mobile radio terminal that includes a keypad adjacent a display and the keypad includes an arrangement of alphanumeric keys, comprising:
activating the camera;
displaying a menu on the display, the menu having a plurality of menu choices, each menu choice corresponding to one of the alphanumeric keys of the keypad and the menu choices displayed in an arrangement to graphically present the correspondence between the menu choices and the keys to a user of the mobile radio terminal; and
changing camera control settings in accordance with a user selected one of the menu choices, the selected menu choice indicated by user operation of the corresponding key.

2. The method of claim 1, wherein the alphanumeric keys form a telephone dialing portion of the keypad and are used to enter a telephone number or contact information in preparation for placing a call with the mobile radio terminal.

3. The method of claim 1, wherein the keypad further includes at least one function key separate from the arrangement of alphanumeric keys.

4. The method of claim 1, wherein displaying the menu is in response to operation of a key from the keypad.

5. The method of claim 1, wherein at least some of the menu choices correspond to camera control settings that prioritize an image parameter over a default priority image parameter for a currently active operational mode of the camera.

6. The method of claim 5, wherein the image parameters are selected from the group of resolution, color, brightness, sharpness, contrast, image file size, signal-to-noise ratio and combinations thereof.

7. The method of claim 5, wherein prioritizing an image parameter involves two key strokes by the user, including a first keystroke to display the menu and a second keystroke to select one of the menu choices.

8. The method of claim 1, wherein the menu choices correspond to operational themes for the camera.

9. The method of claim 1, further comprising emphasizing keys from the keypad that have correspondence to the menu choices using a keypad illumination technique.

10. The method of claim 1, further comprising taking a photograph using a set of camera control settings that correspond to the selected one of the menu choices.

11. A mobile radio terminal, comprising:
a radio circuit for establishing communication with a communications network;
a camera for taking digital photographs;
a display;
a keypad adjacent the display, wherein the keypad includes an arrangement of alphanumeric keys; and
a control circuit configured to execute logic to:
display a menu on the display, wherein the menu has a plurality of menu choices and each menu choice corresponds to one of the alphanumeric keys of the keypad and the menu choices are displayed in an arrangement to graphically present the correspondence between the menu choices and the keys to a user of the mobile radio terminal; and
change camera control settings in accordance with a user selected one of the menu choices, the selected menu choice indicated by user operation of the corresponding key.

12. The mobile radio terminal of claim 11, wherein the alphanumeric keys form a telephone dialing portion of the keypad and are used to enter a telephone number or contact information in preparation for placing a call with the mobile radio terminal.

13. The mobile radio terminal of claim 11, wherein the keypad further includes at least one function key separate from the arrangement of alphanumeric keys.

14. The mobile radio terminal of claim 11, wherein at least some of the menu choices correspond to camera control settings that prioritize an image parameter over a default priority image parameter for a currently active operational mode of the camera.

15. The mobile radio terminal of claim 14, wherein the image parameters are selected from the group of resolution, color, brightness, sharpness, contrast, image file size, signal-to-noise ratio and combinations thereof.

16. The mobile radio terminal of claim 14, wherein prioritizing an image parameter involves two key strokes by the user, including a first keystroke to display the menu and a second keystroke to select one of the menu choices.

17. The mobile radio terminal of claim 1, wherein the menu choices correspond to operational themes for the camera.

18. The mobile radio terminal of claim 1, wherein the control circuit controls illumination of the keys of the keypad to emphasize keys from the keypad that have correspondence to the menu choices.

19. An electronic equipment, comprising:
a camera for taking digital photographs;
a display;
a keypad adjacent the display, wherein the keypad includes an arrangement of keys; and
a control circuit configured to execute logic to:
display a menu on the display, wherein the menu has a plurality of menu choices and each menu choice corresponds to one of the keys of the keypad and the menu choices are displayed in an arrangement to graphically present the correspondence between the menu choices and the keys to a user of the electronic equipment; and
change camera control settings in accordance with a user selected one of the menu choices, the selected menu choice indicated by user operation of the corresponding key.
